(19) United States
(12) Patent Application Publication
(10) Pub. No.: US 2014/0109632 A1
(43) Pub. Date: Apr. 24, 2014

(54) HIGH SECURITY LOCK

(71) Applicants: George Marshall Horne, Lexington, KY (US); Gregory Charles Lainhart, Nicholasville, KY (US)

(72) Inventors: George Marshall Horne, Lexington, KY (US); Gregory Charles Lainhart, Nicholasville, KY (US)

(21) Appl. No.: 13/261,635

(22) PCT Filed: Aug. 5, 2011
(86) PCT No.: PCT/US11/46839

§ 371 Date: Dec. 13, 2013

Related U.S. Application Data
(60) Provisional application No. 61/371,094, filed on Aug. 5, 2010.

(51) Int. Cl. E05B 37/00; E05B 49/00

(52) U.S. Cl. CPC E05B 37/00; E05B 49/002
USPC 70/77

(57) ABSTRACT

A lock assembly (16) for securing a container (10) having an interior region is disclosed. The lock assembly (16) includes a housing (18) positionable on the interior of the container (10), a bolt (26) moveable relative to the housing (18) between an extended position inhibiting access to the interior region of the container (10) and a retracted position to facilitate access to the interior region, a dial (20) positionable on an exterior of the container (10). The dial (20) includes a plurality of indicators (30, 32) indicative of a plurality of dial positions, and an electronic controller (46) operably coupled to the dial (20) to detect the relative position of the dial (20) to determine if a combination entered with the dial (20) provides authorization to move the bolt (26) from the extended position to the retracted position.

### RELATED APPLICATIONS

The present application claims the benefit of U.S. Provisional Patent Application Ser. No. 61/371,094, titled “High Security Lock,” to Horne et al., filed Aug. 5, 2010, the entire disclosure of which is expressly incorporated by reference herein.

### FIELD OF THE INVENTION

The present disclosure relates to access control devices. More particularly, the present disclosure relates to a lock for controlling access to the interior of container, such as a filing cabinet.

### BACKGROUND AND SUMMARY OF THE INVENTION

Containers, such as filing cabinets are used to store items, such as documents, in the interior of the container. Depending on the sensitivity of the item, access to the items located in container may need to be controlled. Locks may be provided on the container to control access to the interior of the container. For example, a filing cabinet may include a drawer or door that is opened providing access to documents in the filing cabinet. A lock may be provided on the drawer or elsewhere on the filing cabinet to block drawer from being opened by unauthorized persons and to be opened by authorized persons.

According to one aspect of the present disclosure, a lock assembly for securing a container having an interior region is provided. The lock assembly includes a housing positionable on the interior of the container, a bolt moveable relative to the housing between an extended position inhibiting access to the interior region of the container and a retracted position to facilitate access to the interior region, a dial positionable on an exterior of the container. The dial includes a plurality of indicators indicative of a plurality of dial positions. The lock assembly further includes an electronic controller operably coupled to the dial to detect the relative position of the dial to determine if a combination entered with the dial provides authorization to move the bolt from the extended position to the retracted position.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a user input positionable to receive input from a user indicative of a code authorized to permit movement of the bolt from to locked to unlocked position, an electronic controller operably coupled to user input to determine the code input by the user, and a battery providing power to the electronic controller, the electronic controller preventing movement of the bolt from the unlocked position to the locked position based on battery use.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a user input positionable to receive input from a user indicative of a code authorized to permit movement of the bolt from to locked to unlocked position, an electronic controller operably coupled to user input to determine the code input by the user, a first battery having sufficient power to power the electronic controller and permit movement of the bolt between the locked and unlocked positions, and a second battery having sufficient power to power the electronic controller and permit movement of the bolt between the locked and unlocked positions.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a user input positionable to receive input from a user indicative of a code authorized to permit movement of the bolt from to locked to unlocked position, an electronic controller operably coupled to user input to determine the code input by the user, an engagement assembly operably positioned between the bolt and the electronic controller to move between an enabled position permitting a user to move the bolt between the locked and unlocked positions and a disabled position preventing a user from moving the bolt between the locked and unlocked position. The electronic controller controls movement of the engagement assembly between the disabled and enabled position. The lock further includes a blocker operably coupled to the bolt to block movement of the bolt between the locked and unlocked position when the electronic controller provides input for the bolt engagement assembly to be in the disabled position.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a user input positionable on an exterior of the container to receive input from a user indicative of a code authorized to permit movement of the bolt from to locked to unlocked position; and an electronic controller positionable on an interior of the container and mechanically operably coupled to the user input to detect a code input from a user into the manual input.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a user input positionable on an exterior of the container to receive input from a user indicative of a code authorized to permit movement of the bolt from to locked to unlocked position; an encoder positionable on the interior of the container to detect input from the user indicative of the code; and an electronic controller operably coupled to encoder to detect the code detected by the encoder.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a user input positionable on an exterior of the container to receive input from a user indicative of a code authorized to permit movement of the bolt from to locked to unlocked position, the position of the user input relative to the housing being adjustable, and an electronic controller operably coupled to the user input to determine the code input by the user, the lock assembly being configured to adjust the determination of the code based on a change in the spatial relationship of the user input relative to the housing.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a user input positionable on an exterior of the container to receive input from a user indicative of a code authorized to permit movement of the bolt from to locked to unlocked position, at least one sensor operably coupled to the user input to detect the user input, and an electronic controller operably coupled to the sensor to determine the code input by the user, the electronic controller translating an output from at least one sensor to a code value.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a dial positionable on an exterior of the container, an electronic controller operably coupled to the dial to detect the relative position of the dial to determine if a combination entered with the dial provides authorization to move the bolt from the extended position to the retracted position, the electronic controller having a sleep mode and an active mode, and a sensor positioned to detect movement of the dial to switch the electronic controller between the sleep and active modes.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a user input positionable on an exterior of the container to receive input from a user indicative of a code authorized to permit movement of the bolt from to locked to unlocked position, an electronic controller operably coupled to user input to determine the code input by the user, and an electromagnetic wave detector positioned to disable movement of the bolt to the unlocked position upon detection of an electromagnetic wave.

According to another aspect of the present disclosure, a lock assembly for securing a container having an interior region is provided. The lock assembly includes a housing, a bolt moveable relative to the housing between a locked position to inhibit access to the interior region of the container and an unlocked position to facilitate access to the interior region, a user input positionable on an exterior of the container to receive input from a user indicative of a code authorized to permit movement of the bolt from to locked to unlocked position, an electronic controller operably coupled to user input to determine the code input by the user, a motor assembly controlled by the electronic controller to control movement of the bolt between the locked and unlocked positions, and a sensor positioned to detect the position of the motor assembly and provide the position to the electronic controller.

According to another aspect of the present invention, a method for determining the position of a dial on a lock coupled to a container having an interior region is provided. The method includes the steps of providing lock having a dial, a bolt moveable relative to the housing between a locked position to inhibit access to the interior region of the container and an unlocked position to facilitate access to the interior region, an electronic controller operably coupled to dial user input to determine a code input by the user, and at least two sensors detecting the position of the dial, and selecting an output of the sensors to detect the position of dial.

According to another aspect of the present disclosure, a method for calibrating the dial positions of a lock is provided. The method includes the steps of providing lock having a dial, a bolt moveable relative to the housing between a locked position to inhibit access to the interior region of the container and an unlocked position to facilitate access to the interior region, an electronic controller operably coupled to dial user input to determine a code input by the user, and a sensors detecting the position of the dial, moving the dial to a plurality of dial positions, detecting the output of the sensor at the plurality of dial positions, and storing the output of the sensor at the plurality of dial positions to correlate the output to the detected dial positions.

According to another aspect of the present disclosure, a method of validating a combination is provided. The method includes the steps of creates an authorized combination, creating a one-way hash using the authorized combination to create a first value, storing the value, and receiving user input combination, creating a one-way hash using the input combination to create a second value, and comparing the second value to the first value to validate the input combination.

### BRIEF DESCRIPTION OF THE DRAWINGS

The above-mentioned and other features and advantages of this disclosure, and the manner of attaining them, will become more apparent and the disclosure itself will be better understood by reference to the following description of embodiments of the invention taken in conjunction with the accompanying drawings, wherein:

FIG. 1 a perspective view of an illustrative container, such as a filing cabinet, and a lock showing the filing cabinet including a case and three drawer secured by the lock;

FIG. 2 is a perspective view of the lock showing the dial, a shaft extending from the dial into the lock case, and the bolt extending from the lock case;

FIG. 3 is a perspective view of the lock of FIG. 2;

FIG. 4A is an assembly view of components of the lock of FIG. 2;

FIG. 4B is an assembly view of components of the lock of FIG. 2;

FIG. 5A is a perspective view of several latching components of the lock of FIG. 2;

FIG. 5B is another perspective view of several latching components of the lock of FIG. 2;

FIG. 6 is a perspective view of a portion of the lock with a cover removed showing the internal workings of the lock and the bolt in an extended position;

FIG. 7 is a top plan view of the lock with the cover removed showing the internal workings of the lock and the bolt in the extended position;

FIG. 8 is a view similar to FIG. 6 showing the bolt in a retracted position;

FIG. 9 is a view similar to FIG. 7 showing the bolt in the refracted position;

FIG. 10 is a cross-sectional view taken along line 10-10 of FIG. 3 showing the cover of the coupled to the case;

FIG. 11 is a view similar to FIG. 10 showing the cover removed from the case and a relock latch in a raised position to block the bolt from retracting;

FIG. 12 is a cross-sectional view taken along line 12-12 of FIG. 3 showing the bolt in an extended position;

FIG. 13 is a view similar to FIG. 12 showing the bolt in a retracted position;

FIG. 14 is a cross-sectional view taken along line 14-14 of FIG. 6 showing an electric motor assembly used to power retraction and extension of the bolt;

FIG. 15 is a bottom view of the lock showing the bolt in an extended position;

FIG. 16 is a view similar to FIG. 16 showing the bolt retracted;

FIG. 17 is a diagrammatic view of an encoder including a pair of rotary potentiometers that detect the position of the dial of the lock of FIG. 3;

FIG. 18 is a graph showing the voltage ratio at the wipers of the potentiometers of FIG. 17 as they are rotated by an encoder gear; and

FIG. 19 is an electrical diagram of several of the electrical components of the lock of FIG. 3.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

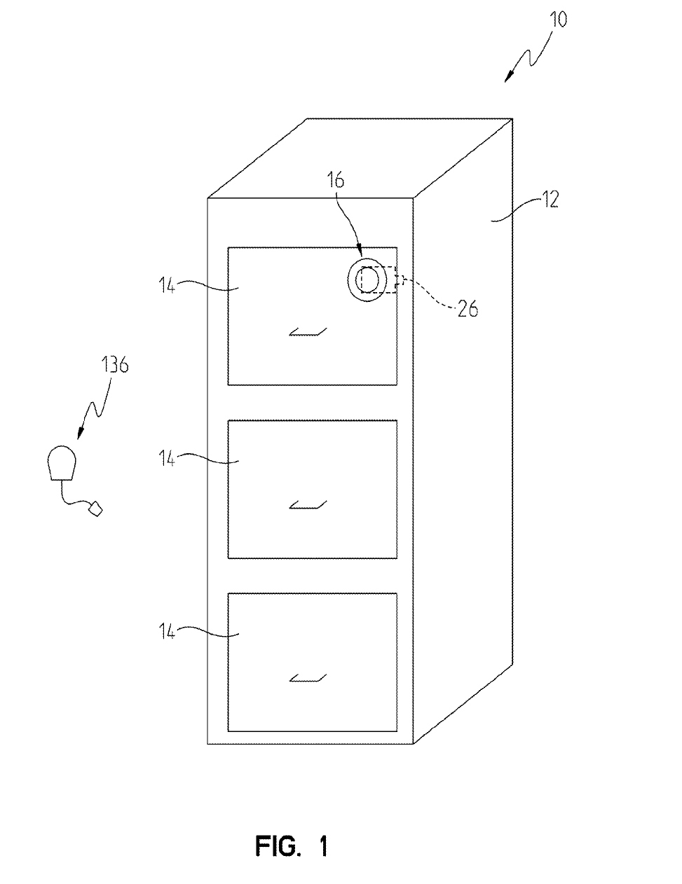

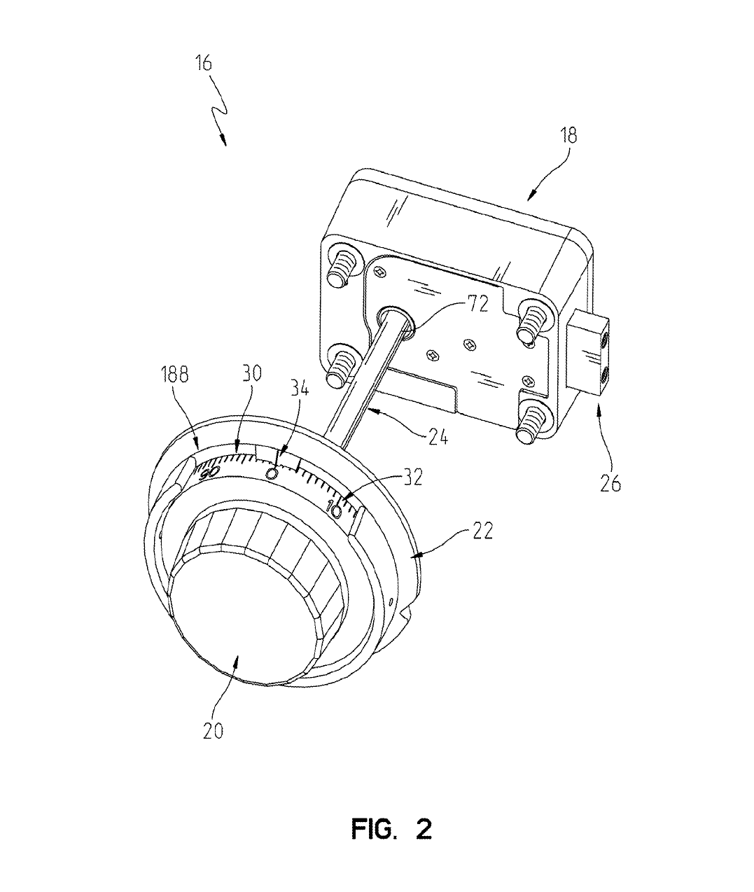

Referring to FIG. 1, a container 10, such as a filing cabinet, is shown that includes a case 12, a plurality of sliding drawers 14, and a lock 16. Lock 16 controls access an interior region of container 10. Lock 16 is mounted on drawer 14 (as shown in FIG. 1) and includes a housing or case 18, dial 20, dial ring 22, dial shaft 24 (as shown in FIG. 2) that extends through drawer 14, and bolt 26 that moves between an extended position to block movement of drawer 14 from a closed position to an open position permitting drawer 14 to be opened. When in the extended position, bolt 26 is received in a recess of case 12 to block sliding of drawer 14 so that any items, such as sensitive documents, are not accessible.

Although container 10 is illustrated as a filing cabinet, lock 16 may be provided on other containers, such as safes and other containers known to those of ordinary skill in the art. Further, although sliding drawer 14 is illustrated, lock 16 may be provided to block movement of other devices that close openings, such as hinged doors or other devices that close openings or block access to interior regions.

As shown in FIG. 1, lock 16 is mounted to drawer 14 so that bolt 26 extends in a horizontal orientation. Lock 16 may be mounted in other orientation so bolt 26 extends vertically or in any other orientation. Lock 16 may also be mounted in different locations other than those shown. For example, lock 16 may be mounted case 12 of container 10 so that bolt 26 engages drawer 14.

Lock 16 may be unlocked if a user enters the correct combination of predetermined positions by rotating dial 20. Lock 16 electronically determines if the user has entered the correct combination of positions of dial 20. Once lock 16 determines the correct positions have been entered, it allows the user to retract bolt 26 by rotating dial 20.

As shown in FIG. 2, dial 20 includes indicators including one hundred marks 30 and corresponding indicia 32 (ex. 90, 0, 10) indicating the reference number of every ten marks 30. Dial ring 22 includes a pointer 34 that indicates the position of dial 20. For example, in FIG. 2, dial 20 is in the zero position. According to the present disclosure, lock 16 is a three combination lock. Thus, a user must know a sequence of three predetermined numbers to unlock lock 16. Initially, the user must completely rotate dial 20 counterclockwise at least four times and stop on the first combination position. Next, the user must completely rotate dial 20 in a clockwise direction at least three times and then stop on the second combination position. Then, the user must completely rotate dial 20 counterclockwise two times and then stop on the third combination position. If the user has entered the three predetermined positions in sequence, lock 16 enables a user to retract bolt 26 as described in greater detail below. Once lock 16 has enabled the retraction of bolt 26, the user rotates dial 20 in the clockwise direction to retract bolt 26 and allow drawer 14 to be opened. Thus, the energy to retract bolt 26 is provided by the user rotating dial 20.

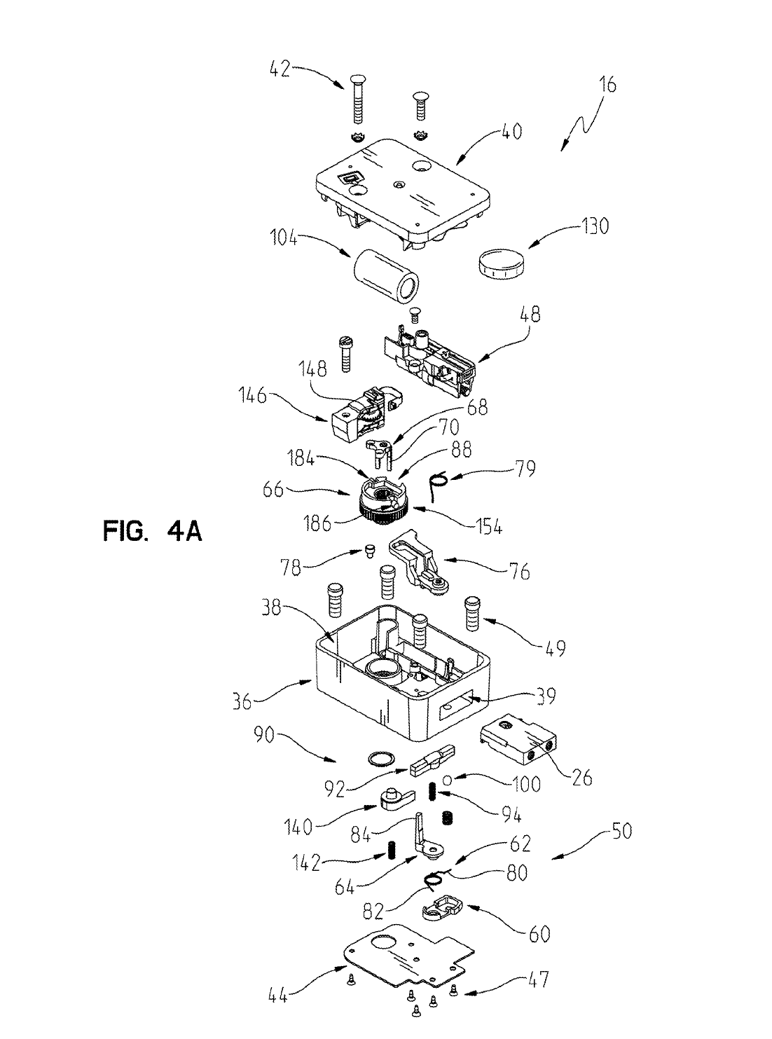

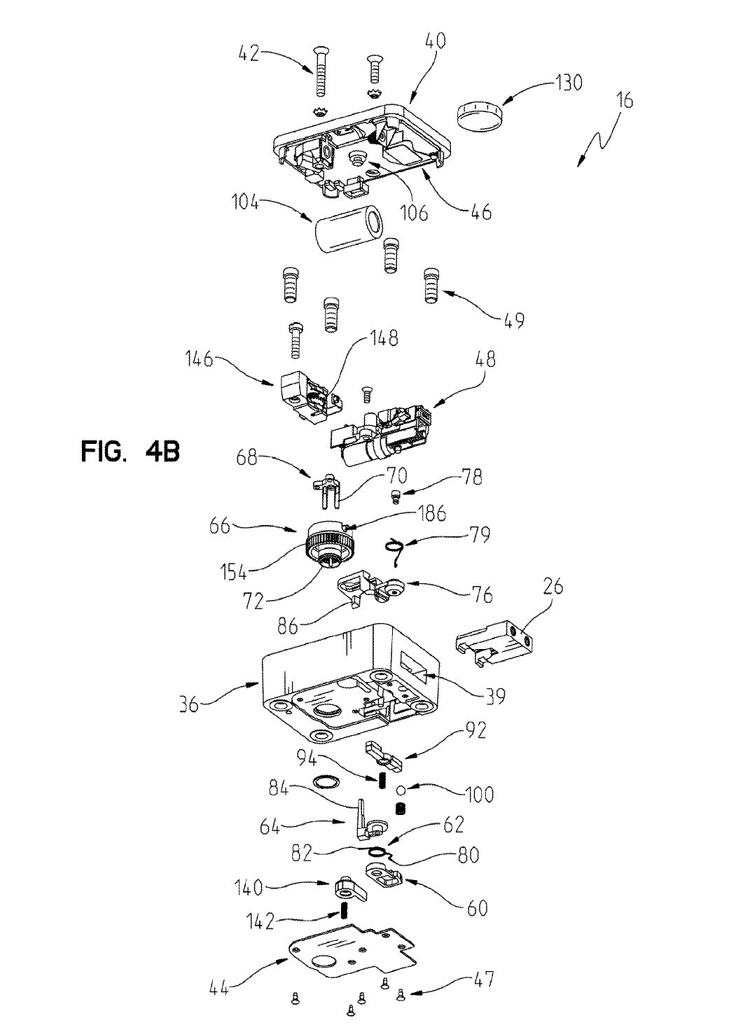

As shown in FIG. 4A, case 18 includes a case body 36 that defines an interior region 38, a front cover 40 that is secured to case body 36 by fasteners 42, and a back cover 44 secured to case body 36 by fasteners 47. Case body 36 includes a bolt opening 39 through which bolt 26 extends. Case 18 is secured to drawer 14 by a plurality of bolts 49 that are only accessible when front cover 40 is removed.

The ability of bolt 26 to move relative to case body 36 is regulated by several components. For example, the ability of a user to retract bolt 26 by rotating dial 20, as discussed above, it regulated by electronics 46, a motor assembly 48, and a dial engagement assembly 50. Electronics 46 is an internal electronic controller that monitors the positions of dial 20 to determine when a user has entered the correct combination. Once the correct combination is entered, electronics 46 activates motor assembly 48, which acts upon dial engagement assembly 50. When acted upon by motor assembly 48, dial engagement assembly 50 operably connects bolt 26 to dial 20 to allow a user rotating dial 20 to retract bolt 26.

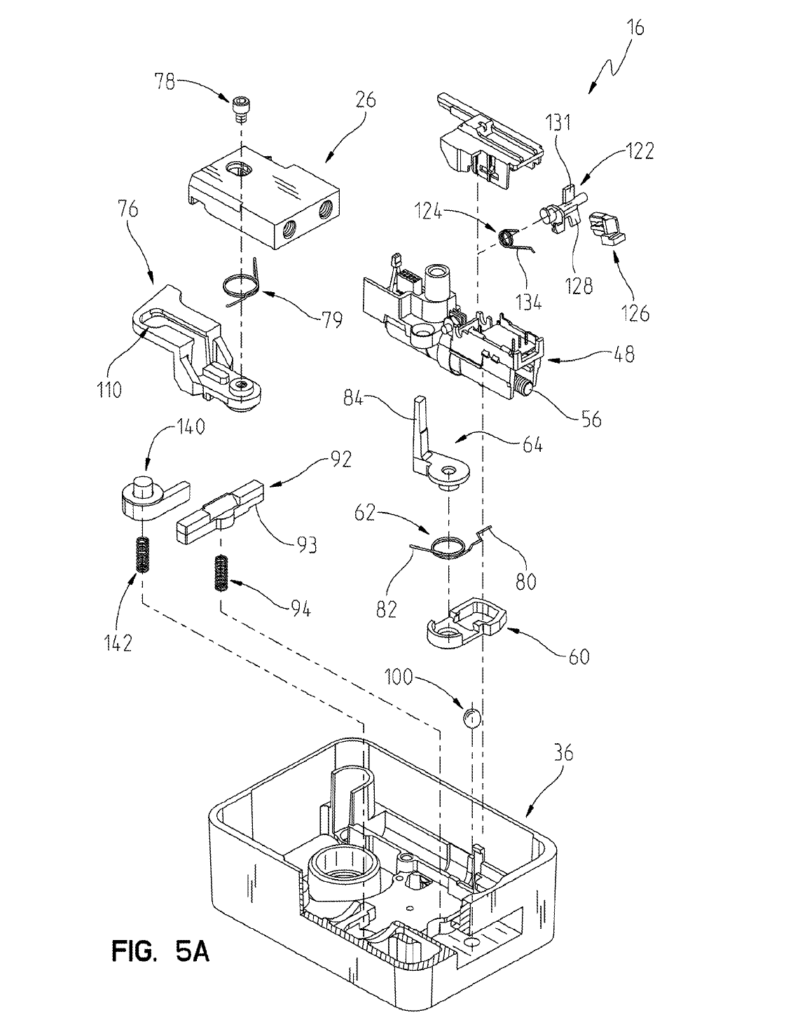

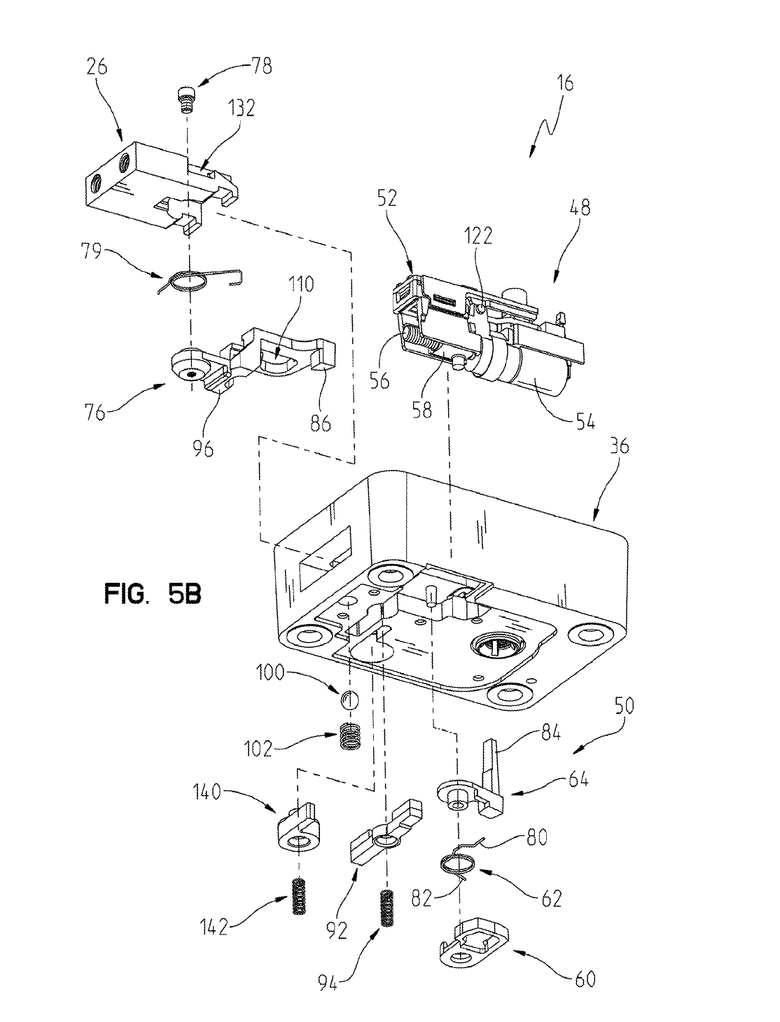

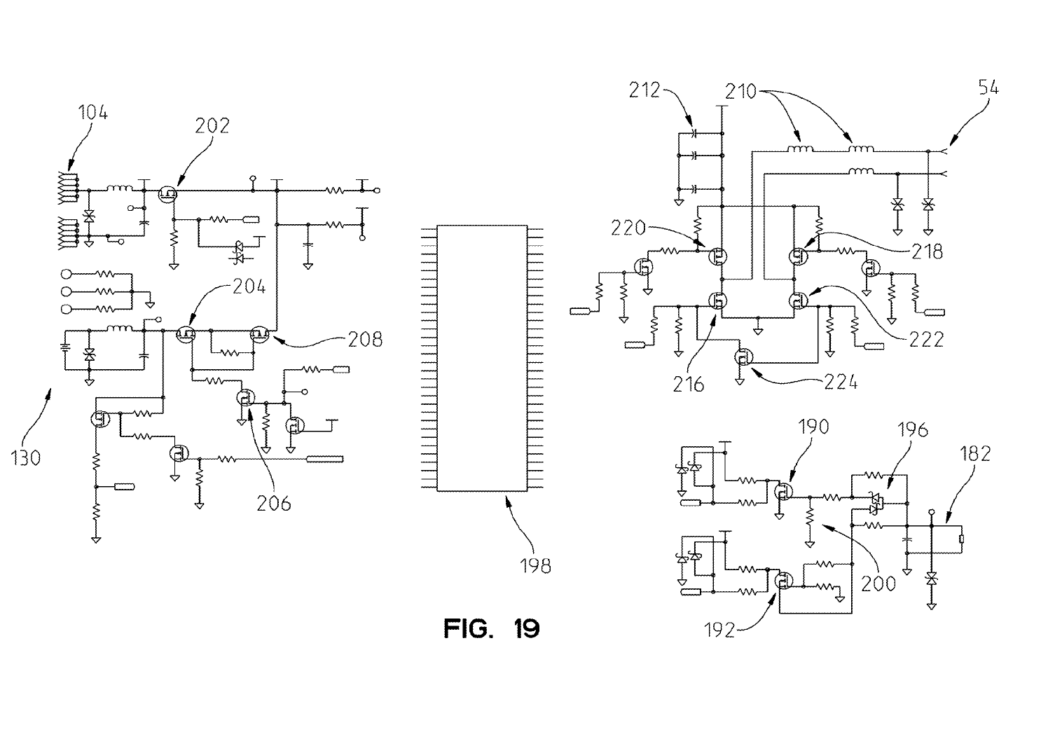

As shown in FIGS. 5A and 5B, motor assembly 48 includes a base 52, motor 54, a threaded shaft 56, and a nut 58 that rides on treaded shaft 56. Motor 54 rotates shaft 56 in one direction or the other based on input from electronics 46. Nut 58 is blocked from rotating by base 52 so that when shaft 56 rotates, nut 58 translates along shaft 59 and interacts with dial engagement assembly 50. Motor 54 drives a linear potentiometer 61 (shown in FIG. 19) to provide the position of nut 58 to electronics 46. Based on the determined position, electronics 46 instructs motor to drive nut 58 to the desired position.

Dial engagement assembly 50 includes motor gear or lever 60, torsion spring 62, motor link or lever 64, a fastener that secures motor gear 60 and motor link 64 to case body 36 for rotation relative thereto, bolt lever 76, and cam 66. Together, these components enable dial shaft 24 to be connected to bolt 26 allowing a user to retract bolt 26.

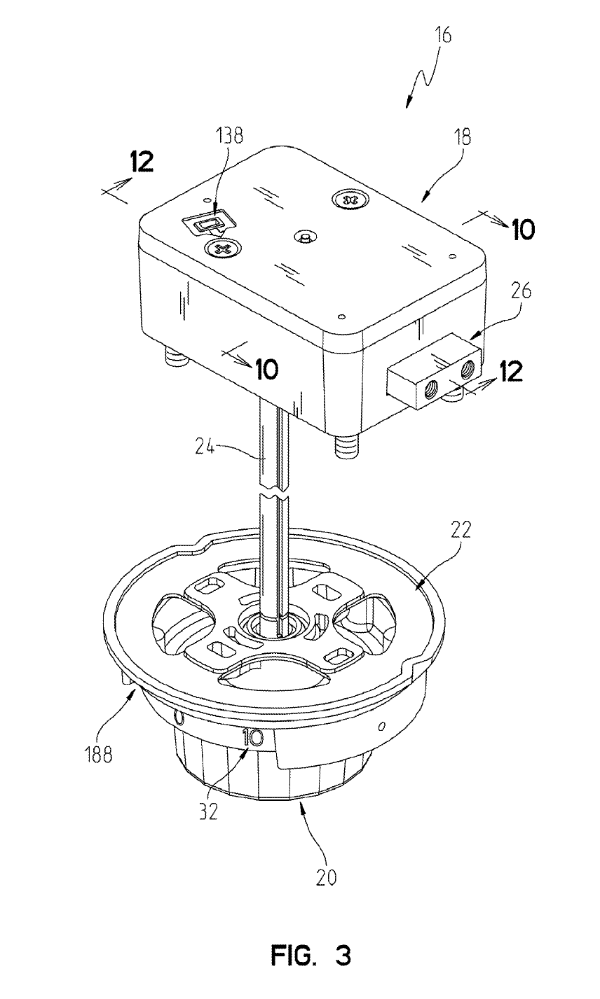

As shown in FIGS. 2 and 3, dial shaft 24 extends from dial 20 into case 18. Shaft 24 threads into a cam 66 that is supported for rotation by case 18. Cam 66 is keyed to shaft 24 by a spline key 68 having legs 70 that extends into corresponding grooves 72 of shaft 24 and cam 66 to block rotation of shaft 24 relative to cam 66. Spline key 68 is coupled to cam 66 with a fastener. During assembly of lock 16 to container 10, an installer extends shaft 24, which is coupled to dial 20, through drawer 14 and threads a threaded end of shaft 24 into cam 66. Next, the installer keys cam 66 to shaft 24 with spline key 68 by inserting legs 70 into grooves 72. Thereafter, cam 66 rotates with dial 20 and shaft 24.

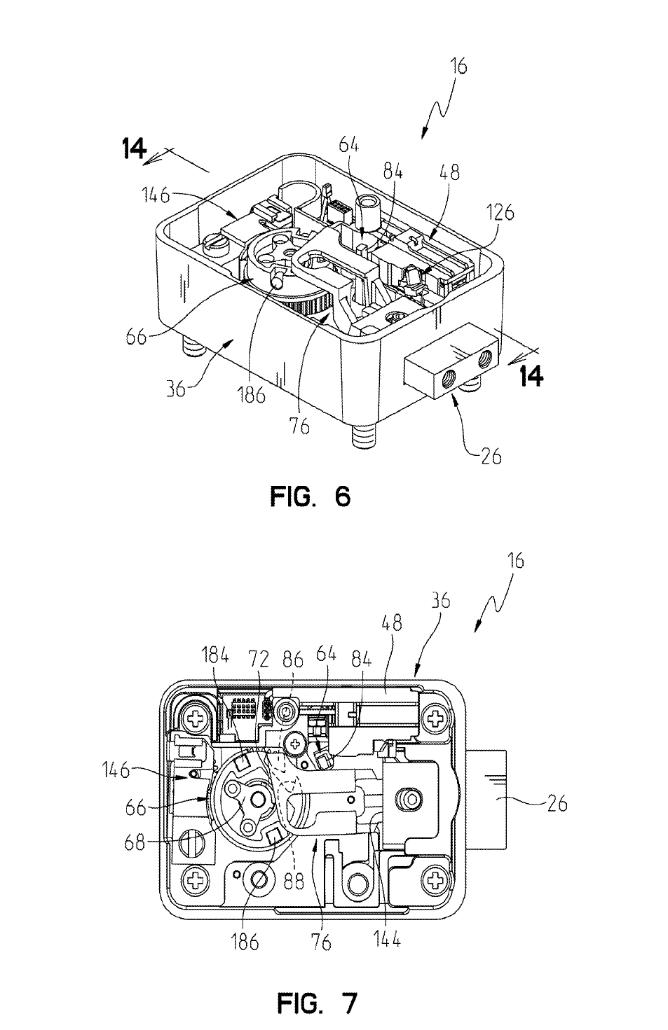

As shown in FIGS. 6-9, lock 16 includes cam 66 and a bolt lever 76 that coupled to bolt 26 that engages cam 66 depending on whether a user has entered the correct combination. Bolt lever 76 is coupled to bolt 26 with a fastener 78 that allows rotation of bolt lever 76 about fastener 78. Lock 16 further includes a torsion spring 79 positioned between bolt lever 76 and bolt 26.

When in the proper position, cam 66 can act upon bolt lever 76 to allow a user rotating dial 20 to retract bolt 26. Through motor assembly 48 and dial engagement assembly 50, electronics 46 moves bolt lever 76 to this position after a user enters the proper combination.

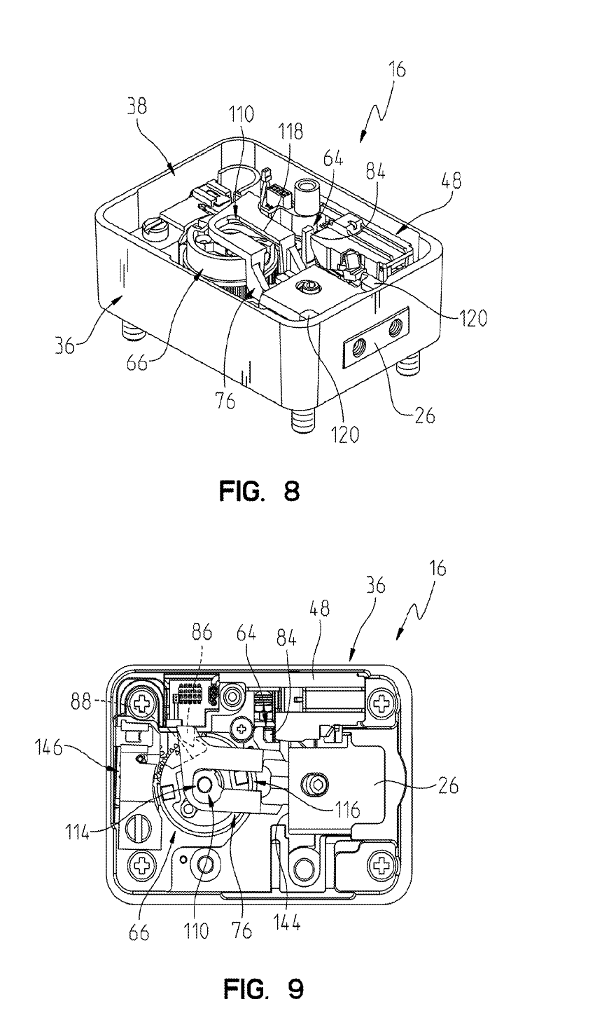

As mentioned above, nut 58 translates when electronics 46 acts upon motor 54. As nut 58 translates away from motor 54 as shown in FIG. 16, it acts upon and rotates motor gear 60. Torsion spring 62 is positioned between motor gear 60 and motor link 64. As nut 58 rotates motor gear 60, motor gear 60 acts upon one arm 80 of torsion spring 62 and increase the torsion of spring 62. The other arm 82 of torsion spring 62 acts upon motor link 64 and cause it to rotate from the position shown in FIGS. 8 and 9 to the position shown in FIGS. 6 and 7. During this movement, motor link 64 rotates bolt lever 76 against the bias of torsion spring 79 and into contact with cam 66 or otherwise positions it for interaction with cam 66.

As shown in FIGS. 5A and 5B, motor link 64 includes a leg 84 that contacts bolt lever 76 and urges it toward cam 66. During this movement, a leg 86 (see FIG. 5B) of bolt lever 76 contacts cam 66. When a user rotates dial 20 and cam 66, a notch 88 of cam 66 catches leg 86 of bolt lever 76. Further rotation of dial 20 and cam 66 pulls bolt lever 76 to retract bolt 26.

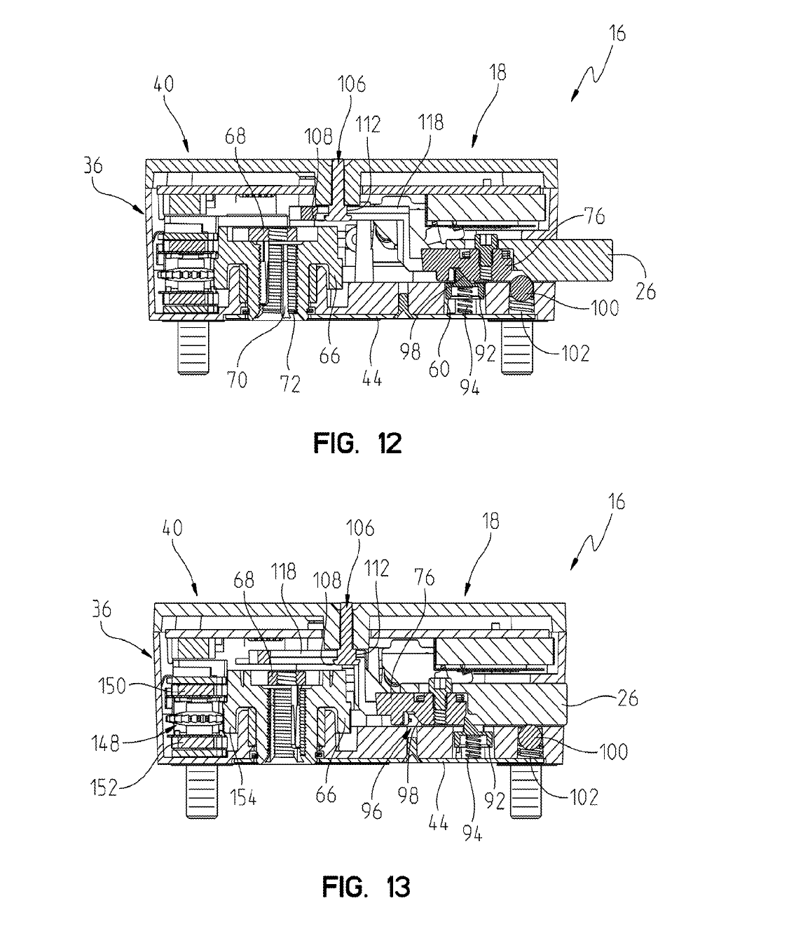

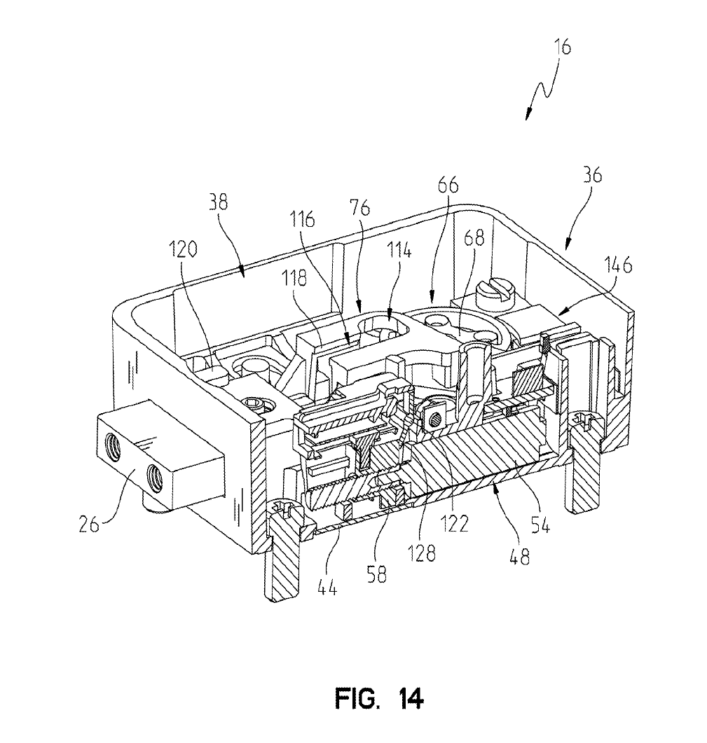

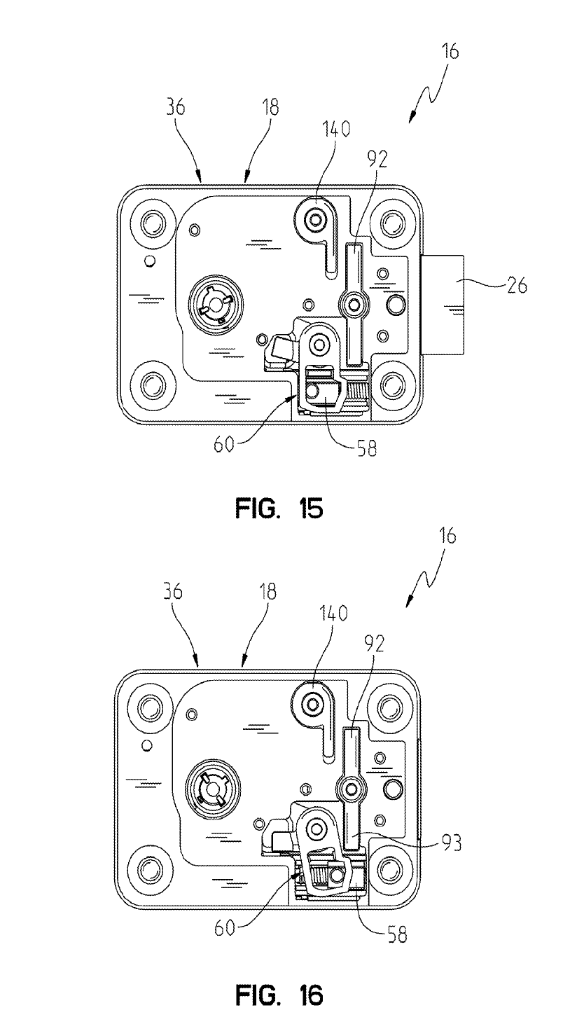

In addition to cam 66 engaging bolt lever 76 to allow for retraction of bolt 26, other conditions within lock 16 must also be met before bolt 26 can be retracted by the user rotating dial 20. As shown in FIGS. 4A, 4B, 12, and 13, lock 16 includes a latch assembly 90 that may block retraction of bolt 26. Latch assembly 90 includes a latch or blocker 92 and spring 94 that urges latch 92 into a notch 96 in bolt lever 76 as shown in FIG. 12. A portion of motor gear 60 is positioned under latch 92 before nut 58 is drive by motor 54 as discussed above. For example, motor gear 60 is rotated counterclockwise from the position shown in FIG. 6 so that a portion of motor gear 60 is positioned within a notch 93 of latch 92. Because motor gear 60 is positioned over latch 92, it blocks latch 92 from moving against spring 94 and out of notch 96 of bolt lever 76. When in notch 96, latch 92 blocks retraction of bolt 26 by bolt lever 76. Thus, if cam 66 is engaged with bolt lever 76, but motor gear 60 is not moved by nut 58 to the position shown in FIG. 15 or 16, a user is unable to retract bolt 26.

When nut 58 moves motor gear 60 to the position shown in FIG. 15 or 16, latch 92 can move out of notch 96. For example, notch 96 includes a ramped surface 98 that acts against a ramped surface of latch 92 to depress latch 92 against spring 94 and eventually out of notch 96 as bolt 26 is retracted by a user rotating dial 20.

After electronics 46 detects that the proper combination has been entered and moves nut 58 to allow retraction of bolt 26, electronics waits for a predetermined time, such as six seconds, and then instructs motor 54 to drive nut 58 back to its start position. If a user does not retract bolt 26 before this waiting period expires and nut returns to its start position, spring 94 urges motor gear 60 to the extreme position. This movement release the torsion in spring 94 so that spring 79 urges bolt lever 76 away from cam 66 so that dial 20 can no longer be used to retract bolt 26. During this movement, motor link 64 also returns to the position shown in FIGS. 8 and 9.

If a user retracts bolt 26 during the waiting period, latch 92 will be in the lowered position shown in FIG. 13 and blocks rotation of motor gear 60 back to the start position. Torsion spring 94 remains under torsion and continues to urge motor link 64 against bolt lever 76 so that bolt lever 76 remains in contact with cam 66.

During retraction of bolt 26, dial 20 reaches a mechanical stop so the user cannot rotate dial 26 any further and bolt 26 is fully retracted. To extend bolt 26, the user rotates dial 20 in the opposite direction so cam 66 pushes on bolt lever 76, which pushes on bolt 26 to extend it from case 18.

As shown in FIGS. 12 and 13, lock 16 includes a spring biased ball 100. When bolt 26 is retracted, ball 100 is urged against spring 102 as shown in FIG. 13. When extended, ball 100 urges and keeps bolt 26 is a fully extend position as shown in FIG. 12.

In the event that container 10 is left unlocked, lock 16 is configured to indicate that an unauthorized person tampered with the internal workings of lock 16. For example, an authorized user may fail to extend bolt 26 while relocking container 10. If an unauthorized user happens upon lock 16 and tampers with the internal workings of lock 16, drawer 14 cannot be completely closed bolt 26 must be extended to open case 18 of lock, as explained in greater detail below. A partially (or completely) open drawer 14 will draw the attention of other users. When such a user inspects the open drawer 14, they will notice that bolt 26 is extended. A trained user will then recognize that lock 16 may have been tampered with (or that battery 104, discussed below, needs replaced).

As shown in FIGS. 12 and 13, lock 16 includes a stud 106 mounted to front cover 40 that prevents front cover 40 from being removed from case body 36 when bolt 26 is retracted. Stud 106 includes a head 108 that extends into opening 110 in bolt lever 76 and annular groove 112. Opening 110 includes a wide portion 114 and a narrow portion 116. When bolt 26 is retracted, head 108 of stud 106 is positioned in narrow portion 116 of opening 112 and annular groove 112 receives a ledge 118 of bolt lever 76. Head 108 is wider than narrow portion 116. As a result, head 108 cannot be withdrawn from opening 110 and bolt lever 76, which is secured to case body 36 by bolt 26, prevents stud 106 and front cover 40 from being removed from case body 36. Case body 36 includes track portions 120 that prevent bolt 26 from being withdrawn through the front of case body 36 when it is coupled to bolt lever 76. As a result, front cover 40 cannot be readily removed when bolt 26 is retracted.

When bolt 26 is extended, head 108 is positioned in wide portion 114 of opening 112 in bolt lever 76. Head 108 is narrower than wide portion 114 of opening 112 so that bolt lever 76 no longer restricts movement of front cover 40 from case body 36. Fasteners 42 must be removed to properly remove front cover 40.

If a person who does not know the proper combination for lock 16 attempts to extends bolt 26 in an effort to remove front cover 40, that person will be unable to extend bolt 26. Even if an unauthorized user attempts to manually engage bolt lever 76 with bolt 26 and attempts to rotate dial 20 or otherwise retract bolt 26 with front cover 40 removed, latch 92 will block retraction of bolt 26 as discussed above. Because the unauthorized user is unable to enter the correct combination, motor 54 and nut 58 will not drive motor gear 60 to the position shown in FIG. 15 or 16. Rather, motor gear 60 remains in the start position under latch 92, blocking retraction of latch 92. Because latch 92 cannot retract, it blocks bolt 26 from retracting.

Because the unauthorized person was unable to retract bolt 26, drawer 14 cannot be fully closed. As stated above, trained personnel should recognize that drawer 14 is not fully closed and bolt 26 is in the extended. As a result, the personnel should notify the proper person(s) that an unauthorized person may have tampered with lock 16.

As stated above, motor 54 is powered by battery 104. Battery 104 has a finite life and should eventually be replaced with a new battery 104. Electronics 46 monitors the remaining life of battery 104 by measuring the voltage, number of uses of battery 104 or otherwise. Once electronics 46 determines that battery 104 has reached a predetermined remaining life, past a predetermined usage, or otherwise, it alters the operation of lock 16 to facilitate replacement of battery 104.

According to the present embodiment, electronics 46 blocks the manual extension of bolt 26 when it is time to replace battery 104. As shown in FIG. 5A, motor assembly 48 includes a crank 122, a torsion spring 124, and a pawl or blocking member 126. Normally, crank 122 and torsion spring 124 hold pawl 126 away from bolt 26 in the position shown in FIG. 6. However, when electronics 46 determines it is time to replace battery 104, it drives nut 58 past the normal latch opening position so that nut 58 engages paddle 128 of crank 122, which rotates pawl 126 down behind bolt 26, preventing it from being retracted.

Movement of nut 58 is powered by an auxiliary battery 130 if necessary. When electronics 46 determines that it is time to replace battery 104, it relies on auxiliary battery 130 as necessary to power operation of lock 16. Auxiliary battery 130 has enough long term power to enable at least one retraction of bolt 26 by a user after a proper combination is entered and to drive nut 58 into engagement with paddle 128. According to an alternative embodiment of the present disclosure, battery 104 may provide the power to move nut 58 into engagement with paddle 128 if sufficient power is available from battery 104.

As a result of nut 58 engaging paddle 128, crank 122 applies torsion to spring 124, which rotates pawl 126 into engagement with bolt 26. When bolt 26 is retracted, pawl 126 drops into a notch 132 formed in bolt 26 and blocks extension of bolt 26. If a user attempts to extend bolt 26 by rotating dial 20, cam 66 and bolt lever 76 will move bolt 26 until pawl 126 runs into interference to block further movement of bolt 26. During this movement, pawl 126 slides along arm 134 of torsion spring 124. By sliding along arm 134, movement of dial 20 is restricted from reaching spring 124, crank 122, and nut 58.

When the user attempts to relock container 10, the user cannot extend bolt 26. A properly trained user must them notify the appropriate person that container 10 cannot be secured. Then, the appropriate person replaces battery 104 and may replace auxiliary battery 130 at the same time. Electronics 46 detects the replacement of battery 104 with a new battery 104 based on the increased voltage supplied by the new battery.

As discussed above, front cover 40 cannot be removed when bolt 26 is retracted. As discussed below in greater detail, an external controller 136 is provided that communicates with electronics 46 to enable extension of bolt 26. Controller 136 couples to electronics 46 through a port 138 on front cover 40, which supports electronics 46. When coupled to port 138, controller 136 commands motor 54 to move nut 58 away from paddle 128 of crank 122. As nut 58 moves away from paddle 128, it engages second paddle 131 of crank 122, which relieves enough torsion applied to spring 124 to move pawl 126 out of latched engagement with bolt 26. As a result, the user can extend bolt 26 using dial 20, which allows removal of front cover 40. When cover 40 is removed, batteries 104, 130 may be replaced. Controller 136 may provide an indication to electronics 46 that batteries 104, 130 have been replaced. The power to move nut 58 away from paddle 128 may be provided by battery 104, battery 130, controller 136, or otherwise.

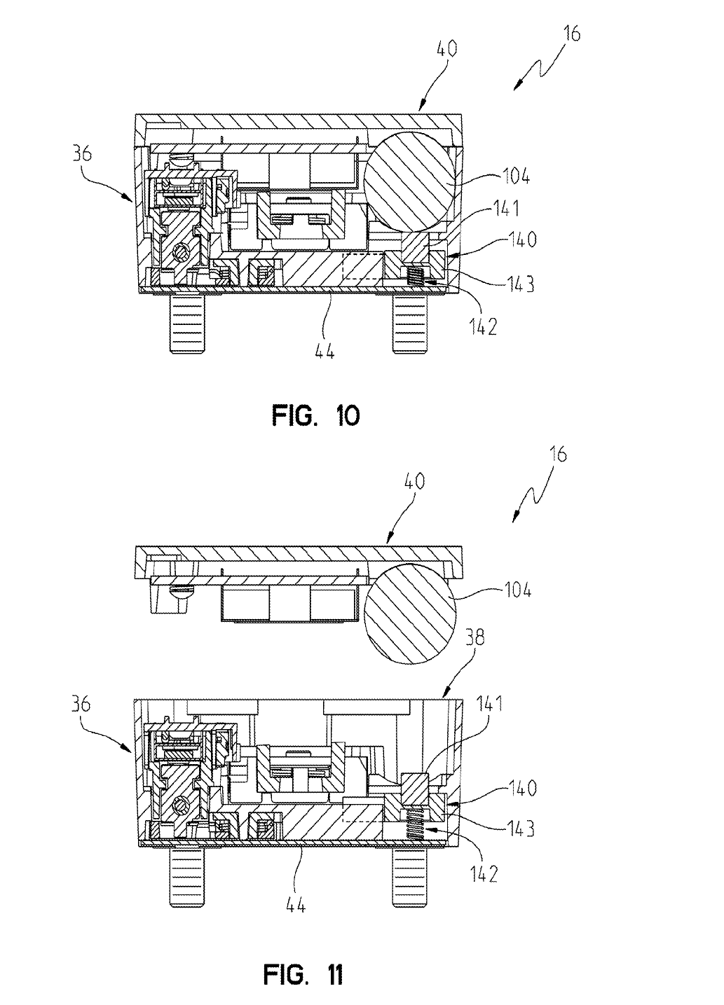

Lock 16 is also configured to block retraction of bolt 26 when front cover 40 is removed from base body 36. As shown in FIGS. 10 and 11, lock 16 includes a tamper latch 140 and a spring 142 that biases tamper latch 140 toward bolt 26. When front cover 40 is positioned on base body 36, battery 104 presses down on tamper latch 140 against the bias of spring 142. When in this position, tamper latch 140 does not block the retraction of bolt 26. However, when front cover 40 is removed, spring 142 urges tamper latch 140 toward bolt 26. When in this position, bolt 26 is positioned behind a rear surface 144 of bolt 26 and blocks it from being retracted. Thus, if someone tampers with lock 16 by breaking or otherwise removing front cover 40 from case body 36, lock 16 resists retraction of bolt 26.

Tamper latch 140 includes a cradle 141 having a lower melting temperature than other components of lock 16, such as base 143 of latch 140. If someone applies excessive heat to lock 16 in an effort to thwart lock 16, cradle 141 will melt and base 143 will be pushed toward bolt 26 by spring 142 and block refraction of bolt 26.

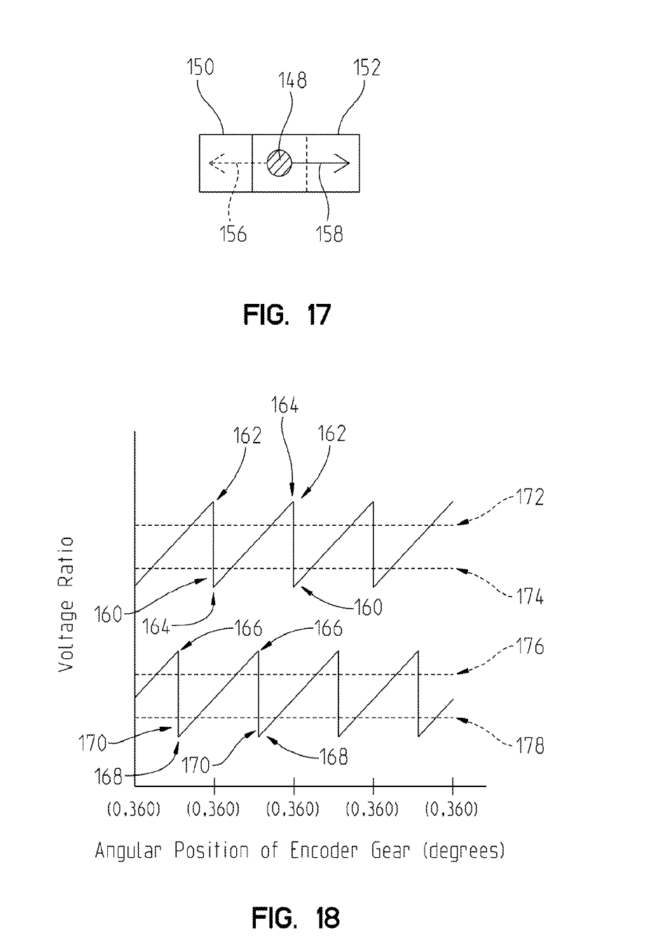

As mentioned above, electronics 46 monitors the position of dial 20 to determine if a user has entered the correct combination. Electronics 46 includes an encoder assembly 146 that measures the position of cam 66. Encoder assembly 146 includes an encoder gear 148 and a pair of rotary potentiometer encoders 150, 152 (see FIG. 17). Cam 66 includes a cam gear 154 that meshes with encoder gear 148 so that as dial 20 rotates cam 66, cam 66 rotates encoder gear 148. Rotary potentiometers 150, 152 measure the rotation of encoder gear 148 and provide an input to electronics 46 indicative of the position of encoder gear 148, cam 66, and dial 20. As a result, electronics 46 is able to determine the position of dial 20 and determine if the correct combination has been entered.

Shaft 24 transfers the dial position from the exterior of container 12 to the interior of container 12 without any electrical wires or other electromagnet transmission paths. As such, no electromagnetic communication path is accessible outside of container 12.

According to the preferred embodiment, potentiometers 150, 152 are offset by 180 degrees. The electrical resistance from wipers 156, 158 of rotary potentiometers 150, 152 with respect to one end of potentiometers 150, 152 changes during rotation of wipers 156, 158 of respective rotary potentiometers 150, 152 by encoder gear 148. Electronics 46 monitors this change in position to determine the position of potentiometers 150, 152.

With the change in resistance across wipers 156, 158, the voltage across wipers 156, 158 also changes. For example, when a voltage is applied to the ends of potentiometer 156, the voltage at wiper 156 of potentiometer 150 with respect to one end changes from a low voltage 160 (see FIG. 18) to a high voltage 162 depending on the position of wiper 156. At a transition point 164, the voltage abruptly changes between low to high depending on the direction that wiper 156 is rotating. Similarly, the voltage of potentiometer 152 has high voltage 166, low voltage 168, and a transition point 170. Because wiper 156 of potentiometer 150 is offset 180 degrees from wiper 158 of potentiometer 152, the transition points 164, 170 occur 180 degrees apart.

According to the preferred embodiment of the present disclosure, controller 136 monitors both the supply/reference voltage provided to potentiometers 150, 152 and the voltage across wipers 156, 158 to determine a voltage ratio (ex. voltage across wipers 156, 158 divided by the reference voltage). As battery 104 uses power, the reference voltage will gradually drop. As the reference voltage gradually drops, the corresponding voltage across wipers 156, 158 will also drop. Because the ratio includes both the reference voltage and the voltage across the wipers 156, 158, the drop in supply/reference voltage has little or no impact on the ratio.

Often, potentiometers are more accurate or consistent in some portion of their range than in others. For example, potentiometers may be less accurate around the transitions points than they are further away from the transition points. To reduce or eliminate the influence of the reduced accuracy, electronics 46 ignores or otherwise reduces the influence of potentiometers 150, 152 in determining the position of dial 20 when the potentiometers 150, 152 are near transition points 164, 170.

Electronics 46 ignore inputs from potentiometers 150, 152 within a predetermined range of either respective transition point 164, 170. According to the preferred embodiment of the present disclosure, electronics 46 only uses input from one of potentiometers 150, 152 at any one time and switches between potentiometers 150, 152 as an input. For example, if electronics 46 is monitoring the position of potentiometer 150 to determine the position of dial 20, it ignores the position of potentiometer 152 until it switches to monitoring the position of potentiometer 152 to determine the position of dial 20 and ignores the position of potentiometer 150.

Electronics 46 monitors the voltage ratio of respective potentiometers 150, 152 to determine when to switch between monitoring and ignoring the respective potentiometers 150, 152. For example, if electronics 46 is monitoring the voltage ratio of potentiometer 150 to determine the position of dial 20, it continues to monitor the voltage ratio until it either reaches either a predetermined high voltage threshold ratio 172 or predetermined low voltage ratio threshold 174 depending on which direction dial 20, cam 66, and encoder gear 146 are being turned. Once either the high or low voltage ratio thresholds 172, 174 are reached, electronics 46 switches to monitoring the voltage ratio of potentiometer 152. Electronics 46 continues to monitor the voltage ratio of potentiometer 152 to determine the location of dial 20 until it reaches either of its high or low voltage ratio thresholds 176, 178. As a result of switching from monitoring one potentiometer 150, 152 to the other potentiometer 152, 150 when the respective high or low voltage ratio thresholds 172, 174, 176, 178 are reached, electronics 46 ignores inputs from potentiometers 150, 152 near to respective transition points 164, 170 and avoids the less accurate information provided by potentiometers 150, 152 when near these transition points 164, 170. Thus, by providing multiple potentiometers (two or more) that are out of phase with each other, more accurate information regarding the position of dial 20 can be obtained. According to another embodiment, only one potentiometer is provided and inputs near the transition point are used to determine the location of dial 20.

Electronics 46 has memory that includes a table including the positions of dial 20 and the voltage ratios for potentiometers 150, 152 that corresponds to these positions. Depending on which potentiometer 150, 152 is being monitored to determine the position of dial 20, electronics 46 will reference the values for the respective potentiometer 150, 152 in the table and cross-reference the position of dial 20 corresponding to that value to determine if the correct dial position is entered. Electronics 46 may also monitor the change of position of dial 20 to determine if dial 20 is rotated the necessary number of times. Either potentiometers or sensor 182 (discussed below) can be used to monitor the number of rotations.

In addition to storing the look up tables, the memory stores the combination necessary to open lock 16. Preferably, the combination is encrypted using a one-way hash with the result hash being stored in memory. Later, combinations entered into lock 16 in an effort to unlock lock 16 are hashed using the one-way hash and the result hash is compared to the stored result hash. If the result hashes match, lock 16 will unlock. As a result of using the one-way hash, the combination cannot be retrieved from memory by someone electronically hacking into lock 16.

Cam gear 154 and encoder gear 148 have a 2:1 gear ratio (i.e. for every turn of cam gear 154, encoder gear 148 rotates twice). As a result, each voltage ratio provided by potentiometers 150, 152 corresponds to two dial positions that are 180 degrees apart. For example, if potentiometer 150 is being monitored and provides a voltage ratio of 0.5, it may correspond to two dial positions that are 180 degrees apart on dial 20 (ex. dial positions 25 and 75).

To determine which of the two dial positions is the actual dial position, electronics 46 includes a sensor 182 (see FIG. 19) that determines the position of cam 66, and therefore, dial 20) within a range of 180 degrees. According to the preferred embodiment of the present disclosure, sensor 182 is a Wiegand sensor/encoder and cam 66 includes a pair of magnets 184, 186 that are 180 degrees apart from each other. Magnet 184 has its north pole extending radially outwardly and magnet 186 has its south pole extending radially outwardly. Thus, during rotation of cam 66, magnet 184 presents a north pole closest to Wiegand sensor 182 and magnet 186 presents a south pole closest to Wiegand sensor 182.

Electronics 46 monitors which pole passes Wiegand sensor 182 to determine which half of the dial positions (ex. dial positions 0-49 or 50-99) dial 20 is positioned. Once electronics 46 knows which half of the dial positions dial 20 is positioned, it can determine which of the two possible dial positions indicated by either potentiometer 150, 152 is the true dial position. For example, if electronics 46 determines that the dial is between positions 0-49 based on the feedback provided by sensor 182 and potentiometers 150, 152 indicate that the dial position is either 25 or 75 (as given in the above example for a voltage ratio of 0.5), electronics 46 knows that the true position is 25, rather than 75. According to alternative embodiments, other gear ratios smaller or larger than 2 may be provided which may require fewer or no sensors to determine the position of cam 66. For example, if a gear ratio of 1 is provided, no such sensor would be required.

Each potentiometer 150, 152 used on locks 16 may provide different resistances for each respective wiper position because of manufacturing tolerances. For example, at dial position 25, potentiometer 150 may provide a resistance of 125 Ohms. For another lock 16, the corresponding value at dial position 25 for another potentiometer 150 may be another value, such as 125.6 Ohms. As such, the monitored voltage ratio for each respective potentiometer 150, 152 may also be different for the same position.

To compensate for these differences, each lock 16 is calibrated to determine more precise voltage ratio values for each potentiometer 150, 152 that correspond to each wiper position and therefore each position of cam 66 and dial 20. To calibrate each lock 16, dial 20 is moved to incremental positions and the voltage ratios are determined for both potentiometers 150, 152 for each incremental dial position. For example, dial 20 may be moved from moved in increments of 5 positions (ex. 0, 5, 10, 15, etc.) and a voltage ratio for each potentiometer 150, 152 is recorded. Voltage ratios for the other dial positions between the increments are extrapolated. For example, dial position 25 may provide a voltage ratio of 0.5 for potentiometer 150 and dial position 30 may provide a voltage ratio of 0.55. Using extrapolation, the voltage ratio of dial positions 26, 27, 28, 29 are determined to be 0.51, 0.52, 0.53, and 0.54, respectively. The voltage ratio values are stored in the memory of electronics 46 for later reference to determine the position of dial 20 as discussed above. Because potentiometers 150, 152 rotate twice for each rotation of dial 20, it may be necessary to record only voltage ratios for half of the dial positions and to use the same voltage ratios for the other half of the dial positions that are 180 degrees apart from the recorded positions. For example, the voltage ratio for dial position 25 (ex. 0.5) may also be used to determine dial position 75.

For dial positions corresponding to voltage ratios near high or low resistance thresholds 172, 174, 176, 178, voltage ratios corresponding to increment dial positions above and below respective high or low voltage ratio thresholds 172, 174, 176, 178 are recorded and extrapolated to determine the voltage ratios up or down to the respective high or low voltage ratio thresholds 172, 174, 176, 178. For example, if dial position 49 is just before high threshold 172 of potentiometer 150, the voltage ratio for dial positions 45 and 50 for potentiometer 150 are detected and extrapolated to determine the voltage ratio for dial position 49. Because dial position 50 occurs above threshold 172, its voltage ratio value would not be used in the memory table to determine if dial is at position 50. Rather, the value associated with position 50 provided by potentiometer 152 would be used because of the potentiometer switch described above. Calibrating the dial positions can be done at any time and done repeatedly, if necessary. For example, the initial calibration may completed by the lock manufacture. However, it may also be completed by an installer or user. Similarly, lock 16 may recalibrated at a later date if necessary due changes in lock 16 (ex. potentiometers 150, 152 may provide different readings over time as they wear down, if at all).

According to one embodiment, not every dial position is calibrated as discussed above. According to this embodiment, only the dial positions that make up the combination are calibrated. For example, if the combination is 25-50-85, only the resistances for dial positions 25, 50, and 85 need to be recorded in the memory of electronics 46. Whenever the combination is changed, the resistances corresponding to the new dial positions of the new combination will also need to be recorded.

Normally, it is desirable for opening 188 in dial ring 22 to face upward so a user can look down at marks 30. Depending on the type of container into which lock 16 is installed, it may be desirable to alter the relative position of bolt 26 (and the majority of the remainder of lock 16) relative to opening 188 of dial ring 22. For example, when lock 16 is installed so that bolt 26 is in a horizontal position (as shown in FIGS. 1 and 2), bolt 26 is perpendicular to the upward direction of opening 188. However, if lock 16 is installed in a container with bolt 26 installed in vertical position (ex. upwardly extending), it may remain preferable to have opening 188 in an upward direction, which would be parallel to the orientation of bolt 26. Because the orientation of ring 22 relative to the remainder of lock 16 changes when bolt 26 is moved from the vertical to horizontal position, the voltage ratio value provided by potentiometers 150, 152 also changes as encoder gear 148 rotates relative to dial ring 22 to its new position relative to the rest of lock 16. In the above example, a voltage ratio of 0.5 is provided for dial position 25 (and 75) when bolt 26 was horizontal. Because this value depends on the dial position of dial 20 and encoder gear 148, a voltage ratio of 0.5 will no longer be indicative of dial position 25 (and 75) once the mounted relative position of bolt 26 and dial ring 22 change. Rather, it will be indicative of other dial positions, such as 0 (and 50) if bolt 26 is installed in a vertical position.

To compensate for different potential installation orientations of bolt 26 (and potentially, dial ring 22 positions), spline key 68 may be installed in multiple different orientations relative to shaft/spindle 24 so that dial ring 22 can be mounted relative to housing 18 in multiple orientations. According the present embodiment, spline key 68 can be mounted to shaft/spindle 24 in four orientations that are 90 degrees apart depending on which groove 72 shaft/spindle 24 spline key legs 70 are inserted.

In addition to or as an alternate, the voltage ratio value corresponding to dial position 0 (and the other value) can be also adjusted after the calibration table is established to compensate for changing the orientation of dial ring 22 or for differences between the installed orientation of housing 16 and dial ring 22 and the calibrated positions. After lock 16 is installed in a container 12, the installer may set dial 20 to the 0 position. Using controller 136, the installer informs electronics 46 that dial 20 is in the 0 position and electronics 46 adjusts the table to match the 0 position. For example, if potentiometer 150 provided a voltage ratio of 0.51 for the 0 position after installation, the memory table is realigned so that the 0 dial position (and 50 dial position) corresponds to a voltage ratio of 0.51 (compared to a factory calibration of 0.5). Similarly, the other positions are re-aligned. For example, in the above example, 0.051 indicated one dial position above 0.5. As a result, a 0.51 reading from potentiometer 150 would correspond to dial position 2. The installer can then test lock 16 to determine if the dial positions are accurate. If necessary, the installer can reset the dial position again. According to one method, the installer is required to move dial 20 to the 0 dial position more than once (ex. three times) and the average voltage ratio of the three attempts is used to determine the voltage ratio corresponding to the 0 dial position.

As discussed above, lock 16 will not retract bolt 26 unless the correct combination is entered and the correct dial positions are determined by electronics 46 by monitoring the stop positions of dial 20 as determined by the voltage ratio values provided by potentiometers 150, 152. According to the present disclosure, electronics 46 will accept a dial position if it is close enough to the necessary position. As a result, electronics 46 will accept voltage ratio values within a range of a given voltage ratio value provided by potentiometers 150, 152. For example, 0.5 is the precise voltage ratio provided by potentiometer 150 for dial position 25 (or 75) in the above example. If a user turns dial 20 to a position close to dial position 25 (ex. dial position 25.25) so that potentiometer provides a value close to 0.5 (ex. 0.501), electronics 46 will accept that dial 20 is close enough to 0.5 and accept the dial position of 25.25 as if it were precisely at dial position 25. Thus, a range of resistance values (ex. 0.495 to 0.505) provided by potentiometers 150, 152 may be recognized by electronics 46 as being acceptable for a given dial position (ex. dial position 25). As a results, dial positions that are not exact (ex. 24.5 to 25.5) will be recognized by electronics 46 as being acceptable for a given dial position (ex. dial position 25). If necessary, the installer can adjust the acceptable ranges using controller 136. For example, the installer can “nudge” the ranges up or down (ex. from range 0.495 to 0.505 to range 0.496 to 0.504). The ranges may also be made tighter or wider to increase or decrease the sensitivity. For example, if the ranges are made smaller, there may be voltage ratio values to with electronics 46 do not assign any dial position.

To increase the total number of possible combinations, the combinations may also be set to fractions of the one hundred marks 30. For example, the possible combinations may include whole or half integers. For example, dial position 51.5 may be one of the required dial positions. As a result, the number of possible dial positions doubles and the total number of combination goes from 1 million to 8 million. The acceptable range of resistances for each whole and half dial position will be reduced. For example, the range of voltage ratio values for example dial position 25 may reduce to 0.4975-0.5025 from 0.495-0.505 to “squeeze” in additional dial positions 24.5 and 25.5.

To conserve battery power, electronics 46 are normally in a sleep mode so that electricity from battery 104 is not being drained. When dial 20 is rotated, electronics 46 wake up to operate the functions of lock 16. Each time Wiegand sensor 182 passes a different pole (ex. it passes a south pole after passing a north pole), it generates a voltage. Electronics 46 detects this voltage and wakes up. Thus, in addition to sensing which half of dial positions dial 20 is positioned, Wiegand sensor 182 also wakes up electronics 46.

According to alternative embodiments of the present disclosure, others sensors, such as reed switches, hall-effect sensors, potentiometers 150, 152, and other sensors may be used to wake up electronics 46. For example, a paired set of reed switches (or a single reed switch with a form C connector) may be positioned to detect dial rotation. The first reed switch is connected to the supply voltage and the second reed switch is connected between the first reed switch and an input to microprocessor 198. The first and second reed switches are normally open, but close at particular dial positions. In other words, the first reed switch moves from the normally open position to a closed position at a different dial position than second reed switch moves from the normally open position to the closed position so that neither reed switch is in the closed position at the same dial position. A capacitor, preferably low leakage, is connected to the electrical path between the first and second reed switches and ground. A resistor is connected to the electrical path between the second reed switch and the input to microprocessor 198. When the first reed switch is in the closed position for the particular dial position, the capacitor is charged. As the dial rotates, the first reed switch opens to cut off the supply voltage and the capacitor remains charged. With additional rotation, the second reed switch closes and allows the capacitor to discharge over the resistor. Through the input to microprocessor 198, microprocessor 198 detects voltage change resulting from the discharge and wakes up electronics 46. To lessen the amount of rotation required to wake up microprocessor 198, additional reed switch pairs can be provided to detect dial rotation. Microprocessor 198 can be configured to monitor the voltage ratio of potentiometers 150, 152 and triggered to wake up electronics 46 when a particular voltage ratio is reached.

A diagram of a portion of electronics 46 is provided in FIG. 19. Wiegand sensor 182 is shown in the lower, right portion of the diagram and is communication with a pair of FET transistors 190, 192 and a resistor 200. Transistor 190 looks for a high signal passed through a diode 196. Transistor 190 wakes up microprocessor 198 of electronics 46 in response to detection of the high signal. In combination with the capacitance of transistor 190, resistor 200 extends the length of the voltage pulse provided by Wiegand sensor 182 to give microprocessor 198 additional time to respond to the signal from transistor 190.

As discussed above, battery 104 provides power during normal operation of lock 16 and battery 130 provides power after battery 104 runs low. Electronics 46 includes transistors 202, 204 (upper, left portion of FIG. 19) to protect against reverse polarity of batteries 104, 130 if installed incorrectly. Transistor 208 blocks leakage from battery 130 during normal operation of battery 104 to keep battery 130 from being drained. Microprocessor 198 monitors the power level of battery 104 and allows battery 130 to power operation after the power level of battery 104 drops below a predetermined level.

As the lower battery condition develops, microprocessor 198 initiates a series of audible beeps to indicate battery 104 is running low. Preferably, microprocessor 198 monitors the remaining power in battery 104 and determines when battery 104 has enough power to operate a predetermined number of lock openings. For example, microprocessor 198 may determine that battery 104 has enough power to open lock 16 one hundred more times. Upon such a determination, microprocessor 198 will active a series of audible beeps (ex. 10 beeps) after lock 16 is opened.

To further conserve battery power, the current draw from battery 130 is preferably controlled at a relatively steady rate during operation of motor 54. However, pulse width modulation is used to start motor 54. Motor 54 is preferable an air core motor, which typically have relatively low inductance. As such, motor 54, itself, does little to smooth out the current draw from battery 130. To increase the inductance and smooth out the current draw from battery 130, inductors 210 are provided as shown in upper, right portion of FIG. 19. Additionally, to reduce the initial current draw from battery 130, capacitors 212 are provided to provide some of the initial current to motor 54. After providing this initial current to motor 54, capacitors 212 are later recharged by battery 130. According to alternative embodiments, other motor types may be provided, such as iron core motors.

As shown in upper, right portion of FIG. 19, electronics 46 further includes transistors 216, 218 that are activated by microprocessor 198 to retract motor nut 58 and transistors 220, 222 that are activated by microprocessor 198 to extend motor nut 58. In an effort to retract bolt 26, someone may to attempt to externally active transistors 216, 218 using an EM pulse. To thwart such an attempt, electronics 46 includes transistor 224 that is positioned very near to transistors 216, 218. If transistors 216, 218 are activated by an external EM pulse, transistor 224 will also be activated to shut off transistor 216, which will prevent refraction of motor nut 58 even though transistors 216 and 218 are activated.

While this invention has been described as having preferred designs, the present invention can be further modified within the spirit and scope of this disclosure. This application is therefore intended to cover any variations, uses, or adaptations of the disclosure using its general principles.

What is claimed is:

1. A lock assembly for securing a container having an interior region, the lock assembly including:
a housing positionable on the interior of the container,
a bolt moveable relative to the housing between an extended position inhibiting access to the interior region of the container and a retracted position to facilitate access to the interior region,
a dial positionable on an exterior of the container, the dial including a plurality of indicators indicative of a plurality of dial positions, and
an electronic controller operably coupled to the dial to detect the relative position of the dial to determine if a combination entered with the dial provides authorization to move the bolt from the extended position to the retracted position.

2. The lock assembly of claim 1, wherein the operable coupling between the dial and the electronic controller is devoid of electric communication paths.

3. The lock assembly of claim 1, wherein the operable coupling between the dial and the electronic controller is a shaft.

4. The lock assembly of claim 1, wherein the electronic controller is positioned in the housing.

5. The lock assembly of claim 1, wherein the electronic controller includes an encoder positioned in the housing.

6. A lock assembly for securing a container having an interior region, the lock assembly including:
a housing,
a bolt moveable relative to the housing between a locked position to inhibit access to the interior region of the container and an unlocked position to facilitate access to the interior region,
a user input positionable to receive input from a user indicative of a code authorized to permit movement of the bolt from to locked to unlocked position,
an electronic controller operably coupled to user input to determine the code input by the user, and
a battery providing power to the electronic controller, the electronic controller preventing movement of the bolt from the unlocked position to the locked position based on battery use.

7. The lock assembly of claim 6, wherein the electronic controller determines the battery use by detecting that the batter is below a predetermined level of power.

8. The lock assembly of claim 6, wherein the electronic controller is to allow movement of the bolt from the unlocked position to the locked position based on detection of the replacement battery.

9. The lock assembly of claim 6, wherein the lock assembly further includes a blocking member and the electronics controls movement of the blocking member to a position blocking extension of the bolt from the unlocked position to the locked position based on battery use.

10. A lock assembly for securing a container having an interior region, the lock assembly including:
a housing,
a bolt moveable relative to the housing between a locked position to inhibit access to the interior region of the container and an unlocked position to facilitate access to the interior region,
a user input positionable to receive input from a user indicative of a code authorized to permit movement of the bolt from to locked to unlocked position,
an electronic controller operably coupled to user input to determine the code input by the user,
a first battery having sufficient power to power the electronic controller and permit movement of the bolt between the locked and unlocked positions, and
a second battery having sufficient power to power the electronic controller and permit movement of the bolt between the locked and unlocked positions.

11. The lock assembly of claim 10, wherein the first and second batteries are positioned within the housing and the housing is positionable within the interior region of the container.

12. The lock assembly of claim 10, wherein the lock is devoid electrical wires extending from outside of container to inside the container.

13. The lock assembly of claim 10, wherein the electronic controller blocks movement of the bolt from the unlocked position to the locked position while the second battery is providing power.

14. A lock assembly for securing a container having an interior region, the lock assembly including:
a housing,
a bolt moveable relative to the housing between a locked position to inhibit access to the interior region of the container and an unlocked position to facilitate access to the interior region,
a user input positionable to receive input from a user indicative of a code authorized to permit movement of the bolt from to locked to unlocked position,
an electronic controller operably coupled to user input to determine the code input by the user,
an engagement assembly operably positioned between the bolt and the electronic controller to move between an enabled position permitting a user to move the bolt between the locked and unlocked positions and a disabled position preventing a user from moving the bolt between the locked and unlocked position, the electronic controller controlling movement of the engagement assembly between the disabled and enabled position, and
a blocker operably coupled to the bolt to block movement of the bolt between the locked and unlocked position when the electronic controller provides input for the bolt engagement assembly to be in the disabled position.

15. The lock assembly of claim 14, wherein the user input is a dial and the electronic controller enables and disables engagement of the dial with the bolt through the engagement assembly to allow retraction of the bolt with the dial.

16. The lock assembly of claim 14, wherein the bolt includes a notch and blocker moves between a first position within the notch and a second position out of notch during movement of bolt between the locked and unlocked position.

17. The lock assembly of claim 16, wherein the engagement assembly includes a link moveable between a position blocking movement of the blocker from the first position and a position permitting movement of the block from the first position.

18. The lock assembly of claim 14, further comprising motor controlled by the electronic controller to move the engagement assembly between the disabled and enabled position.

19. The lock assembly of claim 18, wherein the motor controls operation of the blocker in blocking movement of the bolt.

20. A lock assembly for securing a container having an interior region, the lock assembly including:
a housing,
a bolt moveable relative to the housing between a locked position to inhibit access to the interior region of the container and an unlocked position to facilitate access to the interior region,
a user input positionable on an exterior of the container to receive input from a user indicative of a code authorized to permit movement of the bolt from to locked to unlocked position; and
an electronic controller positionable on an interior of the container and mechanically operably coupled to the user input to detect a code input from a user into the manual input.

21. The lock assembly of claim 20, further comprising a shaft extendable between the exterior of the container and the interior of the container, wherein the user input is a dial and the shaft communication the position of the dial to the electronic controller.

22. The lock assembly of claim 20, wherein the electronic controller includes an encoder positionable within the interior of the container and operably coupled to the user input to detect a code input by the user.

23. The lock assembly of claim 20, wherein the electronic controller is electrically isolated from the user input.

24. The lock assembly of claim 20, wherein mechanical coupling is the only communication between the user input and the electronic controller.

25-67. (canceled)
